(19) United States
(12) Patent Application Publication
(10) Pub. No.: US 2023/0025954 A1
(43) Pub. Date: Jan. 26, 2023

(54) Doorbell Activation Floor Mat Device

(71) Applicant: Deborah Brown, Miami Gardens, FL (US)

(72) Inventor: Deborah Brown, Miami Gardens, FL (US)

(21) Appl. No.: 17/867,855

(22) Filed: Jul. 19, 2022

Related U.S. Application Data
(60) Provisional application No. 63/225,184, filed on Jul. 23, 2021.

(51) Int. Cl. G08B 3/00

(52) U.S. Cl. CPC G08B 3/00

(57) ABSTRACT

The present invention relates to a doorbell activation floor mat device comprised of a body, further comprised of at least one sensor with at least one transmitter. The sensor is preferably a pressure sensor that is activated when a user steps on the body of the device. The sensor then sends a signal to a smart doorbell to activate the doorbell. In this manner, a user need not physically ring a doorbell.

### CROSS-REFERENCE TO RELATED APPLICATION

The present application claims priority to, and the benefit of, U.S. Provisional Application No. 63/225,184, which was filed on Jul. 23, 2021, and is incorporated herein by reference in its entirety.

### FIELD OF THE INVENTION

The present invention relates generally to the field of door mats. More specifically, the present invention relates to a doorbell activation floor mat device comprised of a body, further comprised of at least one sensor with at least one transmitter. The sensor is preferably a pressure sensor that is activated when a user steps on the body of the device. The sensor then sends a signal to a smart doorbell to activate the doorbell. In this manner, a user need not ring a doorbell or unlock a door. Accordingly, the present disclosure makes specific reference thereto. Nonetheless, it is to be appreciated that aspects of the present invention are also equally applicable to other like applications, devices, and methods of manufacture.

### BACKGROUND

Individuals approaching a house typically ring the doorbell of a house to alert the homeowners of their presence. However, touching doorbells may be unsanitary, as the surface of a doorbell may contain many germs and bacteria. Further, an individual may have their hands full and cannot easily touch a doorbell to ring a door.

Therefore, there exists a long-felt need in the art for an improved means of ringing a doorbell. Further, there exists a long-felt need in the art for a doorbell activation floor mat device that allows a user to ring a doorbell without touching the doorbell. In addition, there exists a long-felt need in the art for a doorbell activation floor mat device that does not require any action other than standing to operate a doorbell.

The subject matter disclosed and claimed herein, in one embodiment thereof, comprises a doorbell activation floor mat device. The device is primarily comprised of a body, further comprised of at least one sensor with at least one transmitter. The sensor is preferably a pressure sensor that is activated when a user steps on the body of the device. Once activated, the sensor sends a signal to a smart doorbell to activate the doorbell.

In this manner, the doorbell activation floor mat device of the present invention accomplishes all of the foregoing objectives and provides an improved means of ringing a doorbell that allows a user to ring a doorbell without touching the doorbell. In doing so, the spread of germs and bacteria from the doorbell is prevented. In addition, the device does not require any action other than standing to operate a doorbell, which makes the device simple and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a doorbell activation floor mat device. The device is primarily comprised of a body, further comprised of at least one sensor with at least one transmitter. In a second embodiment, the device may also be comprised of at least one doorbell with at least one receiver and at least one speaker. The body has a top surface, a side surface, and a bottom surface and is preferably rectangular. The body may be shaped like a plurality of indicia such as, but not limited to, patterns, logos, emblems, images, symbols, designs, letters, numbers, words, characters, animals, advertisements, brands, etc. In addition, the top surface may have at least one indicia in the form of a first indicia and/or a second indicia.

The body also houses at least one sensor that is preferably a pressure sensor. The sensor is preferably positioned under the second indicia such that when a user stands on the second indicia of the top surface the sensor is activated. The sensor further has at least one transmitter that is in wireless electrical communication with at least one receiver of at least one doorbell. The doorbell has at least one speaker. Once the sensor is activated (i.e., when a user steps on the body), the speaker can play an audible sound. In one embodiment, the speaker may have at least one microphone that allows a user to record a custom sound that can be played by the speaker.

Accordingly, the doorbell activation floor mat device of the present invention is particularly advantageous as it provides an improved means of ringing a doorbell that allows a user to ring a doorbell without touching the doorbell. Therefore, the device prevents the spread of germs and bacteria from the doorbell. In addition, the device does not require any action other than standing to operate a doorbell, which makes the device simple and easy to use. In this manner, the doorbell activation floor mat device overcomes the limitations of existing doorbells known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of a doorbell activation floor mat device of the present invention in accordance with the disclosed architecture;

FIG. 2 illustrates a side cross-sectional view of one potential embodiment of a doorbell activation floor mat device of the present invention in accordance with the disclosed architecture; and

FIG. 3 illustrates a front view of one potential embodiment of a doorbell of one potential embodiment of a doorbell activation floor mat device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved means of ringing a doorbell. Further, there exists a long-felt need in the art for a doorbell activation floor mat device that allows a user to ring a doorbell without touching the doorbell. In addition, there exists a long-felt need in the art for a doorbell activation floor mat device that does not require any action other than standing to operate a doorbell.

The present invention, in one exemplary embodiment, is comprised of a doorbell activation floor mat device, primarily comprised of a body, further comprised of at least one sensor with at least one transmitter. In an additional embodiment, the device may also be comprised of at least one doorbell with at least one receiver and at least one speaker. The body has a top surface, a side surface, and a bottom surface and is preferably rectangular. The body may be shaped like a plurality of indicia such as, but not limited to, patterns, logos, emblems, images, symbols, designs, letters, numbers, words, characters, animals, advertisements, brands, etc. In addition, the top surface may have at least one indicia in the form of a first indicia and or a second indicia.

The body also houses at least one sensor. The sensor is preferably a pressure sensor. The sensor is preferably positioned under the second indicia such that when a user stands on the second indicia of the top surface the sensor is activated. The sensor further has at least one transmitter that is in wireless electrical communication with at least one receiver of at least one doorbell. The doorbell has at least one speaker, wherein once the sensor is activated (i.e., when a user steps on the body), the speaker can play an audible sound. The speaker may have at least one microphone that allows a user to record a custom sound that can be played by the speaker.

As a result, the doorbell activation floor mat device provides an improved means of ringing a doorbell that allows a user to ring a doorbell without touching the doorbell. Therefore, the device prevents the spread of germs and bacteria from the doorbell. In addition, the device does not require any action other than standing to operate a doorbell, which makes the device simple and easy to use. In this manner, the doorbell activation floor mat device overcomes the limitations of existing doorbells known in the art.

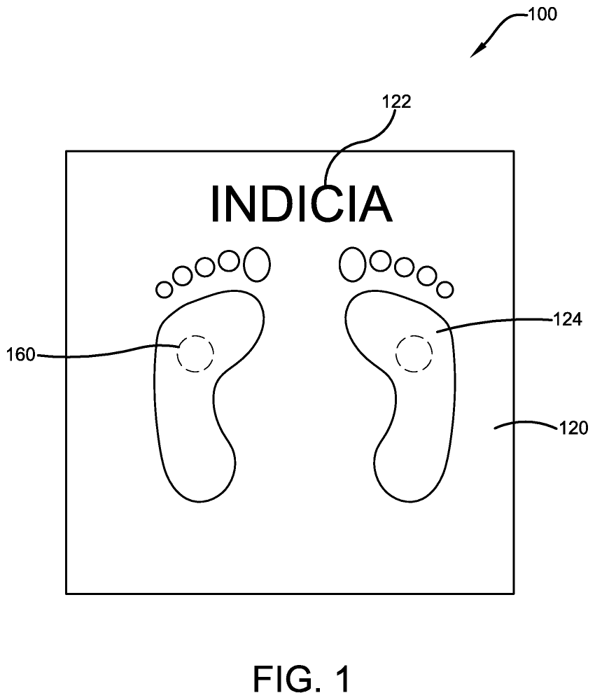

Referring initially to the drawings, FIG. 1 illustrates a top view of one potential embodiment of a doorbell activation floor mat device 100 of the present invention in accordance with the disclosed architecture. The device 100 is primarily comprised of a body 110, further comprised of at least one sensor 160 with at least one transmitter 170. In a second embodiment, the device 100 may also be comprised of at least one doorbell 200 with at least one receiver 220 and at least one speaker 210. The body 110 has a top surface 120, a side surface 130, and a bottom surface 140 and is preferably made from a waterproof material. However, the body 110 (or any surface 120,130,140) may be made from any material such as, but not limited to, wood and/or natural fibers such as, but not limited to, coir, rubber, synthetic material, and grasses such as, but not limited to, jute. The bottom surface 140 may be made from a non-slip material such as, but not limited to, rubber.

The body 110 is preferably rectangular, but may be any shape known in the art such as, but not limited to, square, triangular, polygonal, etc. In addition, the body 110 may be shaped like a plurality of indicia such as, but not limited to, patterns, logos, emblems, images, symbols, designs, letters, numbers, words, characters, animals, advertisements, brands, etc. In addition, the top surface 120 may have at least one indicia in the form of a first indicia 122 and/or a second indicia 124. The first indicia 122 is preferably a word greeting such as, but not limited to, “Welcome”. The second indicia 124 is preferably the shape of a pair of feet. However, either indicia 122,124 may be any indicia known in the art such as, but not limited to, patterns, logos, emblems, images, symbols, designs, letters, numbers, words, characters, animals, advertisements, brands, etc.

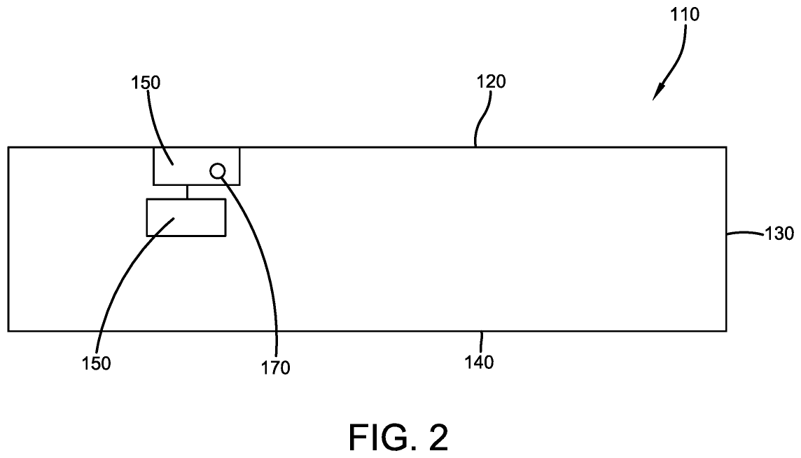

FIG. 2 illustrates a side cross-sectional view of one potential embodiment of a doorbell activation floor mat device 100 of the present invention in accordance with the disclosed architecture. The body 110 also houses at least one sensor 160. The sensor 160 is preferably a pressure sensor. The sensor 160 is preferably positioned under the second indicia 124 such that when a user stands on the indicia 124 of the top surface 120 the sensor 160 is activated.

The sensor 160 is further powered by at least one battery 150. The battery 150 may be a disposable battery 150 or a rechargeable battery 150 in the form of an alkaline, nickel-cadmium, nickel-metal hydride battery 150, etc., such as any 3V-12 volts DC battery 150 or other conventional battery 150 such as A, AA, AAA, etc., that supplies power to the device 100. Throughout this specification the terms “battery” and “batteries” may be used interchangeably to refer to one or more wet or dry cells or batteries of cells in which chemical energy is converted into electricity and used as a source of DC power. References to recharging or replacing batteries 150 may refer to recharging or replacing individual cells, individual batteries 150 of cells, or a package of multiple battery cells as is appropriate for any given battery 150 technology that may be used.

The sensor 160 further has at least one transmitter 170. The transmitter 170 is in wireless electrical communication with at least one receiver 220 of at least one doorbell 200. The transmitter 170 and receiver 220 may communicate via any form of wireless electrical communication known in the art such as, but not limited to, Wi-Fi, Bluetooth, RFID, etc.

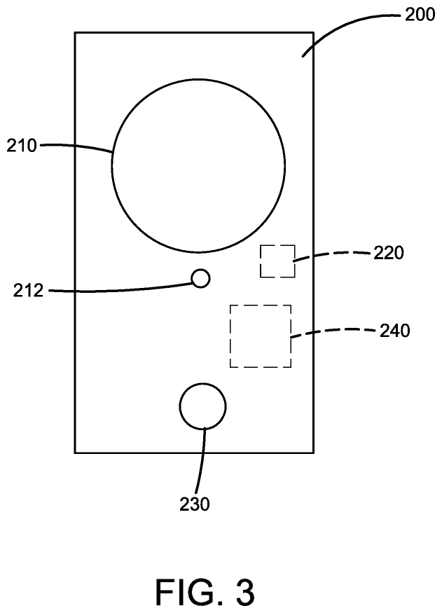

FIG. 3 illustrates a front view of one potential embodiment of a doorbell 200 of one potential embodiment of a doorbell activation floor mat device 100 of the present invention in accordance with the disclosed architecture. In one embodiment, the transmitter 170 may electrically communicate with any smart doorbell known in the art. In a differing embodiment, the device 100 is comprised of a smart doorbell 200 that has at least one speaker 210 and is powered by at least one battery 240. Once the sensor 160 is activated (i.e., when a user steps on the body 110), the speaker 210 can play an audible sound. The sound may be in the form of a ringtone, song, phrase, sound effect, etc. The speaker 210 may have a plurality of pre-recorded or custom sounds that can be selected using at least one button 230 of the doorbell 200. In one embodiment, the speaker 210 may have at least one microphone 212 that allows a user to record a custom sound that can be played by the speaker 210.

In one embodiment, the speaker 210 may be separate but in electrical communication with the doorbell 200. This allows the speaker 210 to be positioned within a home and the doorbell 200 to be positioned on the exterior of a home. The button 230 of the doorbell 200 may also function in the manner of a traditional doorbell to produce a sound from the speaker 210 when the button 230 is pushed.

In one embodiment, the sensor 160 may have a minimum weight needed to trigger activation of the sensor 160, such as, but not limited to, 60 pounds. This ensures the sensor 160 is not triggered by a delivered package placed on the body 110, but rather by a human stepping on the body 110. In another embodiment, the sensor 160 may be a proximity sensor or a motion sensor that instead senses when a user is atop the top surface 120.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “doorbell activation floor mat device” and “device” are interchangeable and refer to the doorbell activation floor mat device 100 of the present invention.

Notwithstanding the foregoing, the doorbell activation floor mat device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the doorbell activation floor mat device 100 as shown in the FIGS. are for illustrative purposes only, and that many other sizes and shapes of the doorbell activation floor mat device 100 are well within the scope of the present disclosure. Although the dimensions of the doorbell activation floor mat device 100 are important design parameters for user convenience, the doorbell activation floor mat device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A doorbell activation floor mat device comprising:
a body comprised of a top surface
a battery;
a sensor comprised of a transmitter; and
a doorbell comprised of a receiver, a speaker, and a battery.

2. The doorbell activation floor mat device of claim 1, wherein the sensor is a pressure sensor.

3. The doorbell activation floor mat device of claim 2, wherein the pressure sensor is activated by a weight greater than 60 pounds.

4. The doorbell activation floor mat device of claim 1, wherein the transmitter is in wireless electrical communication with the receiver.

5. The doorbell activation floor mat device of claim 3, wherein an activation of the sensor produces a sound from the speaker.

6. A doorbell activation floor mat device comprising:
a body comprised of a top surface having a first indicia and a second indicia;
a battery;
a sensor comprised of a transmitter; and
a doorbell comprised of a receiver, a speaker, a button and a battery.

7. The doorbell activation floor mat device of claim 6, wherein the sensor is positioned under the second indicia of the top surface.

8. The doorbell activation floor mat device of claim 6, wherein the first indicia is a word greeting.

9. The doorbell activation floor mat device of claim 6, wherein the sensor is a motion sensor.

10. The doorbell activation floor mat device of claim 9, wherein activation of the motion sensor produces a sound from the speaker.

11. The doorbell activation floor mat device of claim 10, wherein the sound is a ringtone, a song, a phrase or a sound effect.

12. The doorbell activation floor mat device of claim 6, wherein the speaker is comprised of a microphone.

13. The doorbell activation floor mat device of claim 6, wherein the second indicia is a pattern, a logo, an emblem, an image, a symbol, a design, a letter, a word, a character, an animal, an advertisement or a brand.

14. A doorbell activation floor mat device comprising:
a body comprised of a top surface having a first indicia and a second indicia, and a bottom surface;
a battery;
a sensor comprised of a transmitter positioned between the top surface and the bottom surface; and
a doorbell comprised of a receiver, a speaker, a button, and a battery.

15. The doorbell activation floor mat device of claim 14, wherein the second indicia is a pair of feet.

16. The doorbell activation floor mat device of claim 14, wherein the sensor is a proximity sensor.

17. The doorbell activation floor mat device of claim 14, wherein the transmitter is in wireless electrical communication with the receiver.

18. The doorbell activation floor mat device of claim 14, wherein the button produces a sound from the speaker.

19. The doorbell activation floor mat device of claim 18, wherein the sound is a ringtone, a song, a phrase, or a sound effect.

20. The doorbell activation floor mat device of claim 14, wherein the speaker is physically separate from the doorbell.
